(19) United States
(12) Patent Application Publication
(10) Pub. No.: US 2014/0331704 A1
(43) Pub. Date: Nov. 13, 2014

(54) Pressure Relief Valve With Protective Cap

(71) Applicant: Carrier Corporation, Farmington, CT (US)

(72) Inventors: Jason R. Kondrk, Clay, NY (US); Zvonko Asprovski, Liverpool, NY (US)

(21) Appl. No.: 14/364,354

(22) PCT Filed: Dec. 3, 2012
(86) PCT No.: PCT/US2012/067516

§ 371 Date: Jun. 11, 2014

Related U.S. Application Data
(60) Provisional application No. 61/569,505, filed on Dec. 12, 2011.

(51) Int. Cl. F16K 27/12; F25B 41/04; F25B 1/00; F16K 17/16; F16K 17/04

(52) U.S. Cl. CPC F16K 27/12; F16K 17/16; F16K 17/04; F25B 1/005; F25B 41/04
USPC 62/190; 137/343; 137/68.19

(57) ABSTRACT

A pressure relief valve (20) for use in connection with a high pressure fluid system has a protective cap (22) for limiting the exposure of personnel to high pressure fluid venting from the pressure relief valve. In an embodiment, the protective cap includes a cylindrical cap body (52) mounted to a distal end (28) of the valve body (24) of the pressure relief valve and a skirt flange (54) extending circumferentially about an open end of the cap body for deflecting the streams of high pressure fluid venting from the pressure relief valve away from an outwardly directed path. A circumferential seal body (70) may be disposed between an inner circumferential surface (66) of the cap body and an outer circumferential surface (68) of the distal end of the valve body.

### CROSS-REFERENCE TO RELATED APPLICATION

Reference is made to and this application claims priority from and the benefit of U.S. Provisional Application Ser. No. 61/569,505, filed Dec. 12, 2011, and entitled PRESSURE RELIEF VALVE WITH PROTECTIVE CAP, which application is incorporated herein in its entirety by reference.

### BACKGROUND

This disclosure relates generally to pressure relief valves and, more particularly to a pressure relief valve having a protective cap for limiting potential exposure of personnel in proximity to the pressure relief valve to high pressure fluid in the event the pressure relief valve actuates.

Pressure relief valves are commonly installed as over-pressure regulation devices on closed systems wherein a fluid is contained or circulated under high pressure. These pressure relief valves may be single use or multiple use valves. Single use pressure relief valves, such as, for example, rupture disc pressure relief valves, are designed to open to relieve an over pressure condition, but not close afterward. Multiple use pressure relief valves, such as for example spring-loaded pressure relief valves, are designed to open to relieve an over pressure condition and to close and reseat when the over pressure condition has been relieved. In either design, the pressure relief valve is threaded to a nipple defining a flow passage in fluid flow communication with the closed system.

Pressure relief valves are used in high-pressure refrigerant vapor compression systems wherein a high pressure refrigerant is circulated through a flow circuit. In a conventional refrigerant vapor compression system, a refrigerant is pressurized by a compressor and circulated through a refrigerant circuit including a refrigerant heat rejection heat exchanger, an evaporator expansion device, and a refrigerant heat absorption heat exchanger, interconnected in serial flow relationship by tubing forming the refrigerant circuit. Some refrigerant vapor compression systems further include an economizer, typically disposed in the refrigerant circuit between the refrigerant heat rejection heat exchanger and the refrigerant heat absorption heat exchanger, together with an associated economizer expansion device. The fluid pressure developed within the refrigerant circuit largely depends upon the characteristics of the particular refrigerant within the system. For example, a refrigerant vapor compression system charged with carbon dioxide refrigerant will generally operate in a transcritical cycle and fluid pressure within the high side of the refrigerant circuit can exceed 2250 pounds per inch gauge.

Conventional rupture disc pressure relief valves commonly used in connection with refrigerant vapor compression systems are typically provided with a single vent hole disposed to discharge the high pressure refrigerant vapor passing therethrough as an axially directed stream. Therefore, in the event of an over pressure condition, when the pressure relief valve actuates, the high pressure refrigerant vented through the valve chamber of the pressure relief valve exits either as a single high pressure stream directly axially outwardly parallel to the longitudinal axis of the valve (that is upwardly for vertically installed valve or horizontally for a horizontally installed valve) or radially outwardly perpendicular to the longitudinal axis of the valve.

### SUMMARY

In an aspect, a pressure relief valve for use in connection with a high pressure fluid system has a protective cap for limiting the exposure of personnel to high pressure fluid venting from the pressure relief valve. The protective cap includes a skirt flange for deflecting the streams of high pressure fluid venting from the pressure relief valve away from an outwardly directed path.

In an embodiment, a pressure relief valve for use in connection with a high pressure fluid system includes a valve body extending along a longitudinal axis and defining a valve chamber, and a protective valve cap. The valve body has a distal end having at least one vent hole opening through the distal end. The vent hole defines a fluid flow passage for venting high pressure fluid from the valve chamber to an environment exterior of the valve body in a direction generally transverse to the longitudinal axis. The protective cap is mounted to the distal end of the valve body and has a skirt flange disposed in spaced relationship to the distal end of the valve body. The skirt flange defines a surface juxtaposed opposite the at least one vent hole.

In an embodiment, the protective cap has a cylindrical cap body secured to the distal end of the valve body, the cap body having a closed base end and an open end, the skirt flange extending circumferentially about the open end of the cap body. The protective cap may be secured directly to the valve body by threading the cap body directly to the distal end of the valve body or indirectly by threading the cap body to a compression spring loading set screw and threading the set screw directly to the distal end of the valve body. In an embodiment, the compression spring loading set screw is formed integrally with the cap body.

A circumferential seal member may be disposed between an inner circumferential surface of the cap body and an outer circumferential surface of the distal end of the valve body. In an embodiment, the circumferential seal member is a compressible O-ring seal.

### BRIEF DESCRIPTION OF THE DRAWINGS

For a further understanding of the disclosure, reference will be made to the following detailed description which is to be read in connection with the accompanying drawing, where:

FIG. 1 is a side elevation view of an embodiment of a pressure relief valve as disclosed herein mounted to a fluid flow conduit;

FIG. 2 is a side elevation view of the embodiment of FIG. 1, with the proximal portion of the pressure relief valve in section and illustrating the pressure relief valve in a sealed condition;

FIG. 3 is a side elevation view, partly in section, illustrating an embodiment of the distal end of the pressure relief valve shown in FIG. 1;

FIG. 4 is a side elevation view, partly in section, illustrating another embodiment of the distal end of the pressure relief valve shown in FIG. 1;

FIG. 5 is a side elevation view, partly in section, illustrating a further embodiment of the distal end of the pressure relief valve shown in FIG. 1;

FIG. 6 is a side elevation view, partly in section, illustrating another embodiment of the protective cap of the pressure relief valve disclosed herein;

FIG. 7 is a side elevation view of a further embodiment of the pressure relief valve disclosed herein; and

FIG. 8 is a schematic representation of a refrigerated vapor compression system equipped with a plurality of pressure relief valves for over pressure regulation.

### DETAILED DESCRIPTION

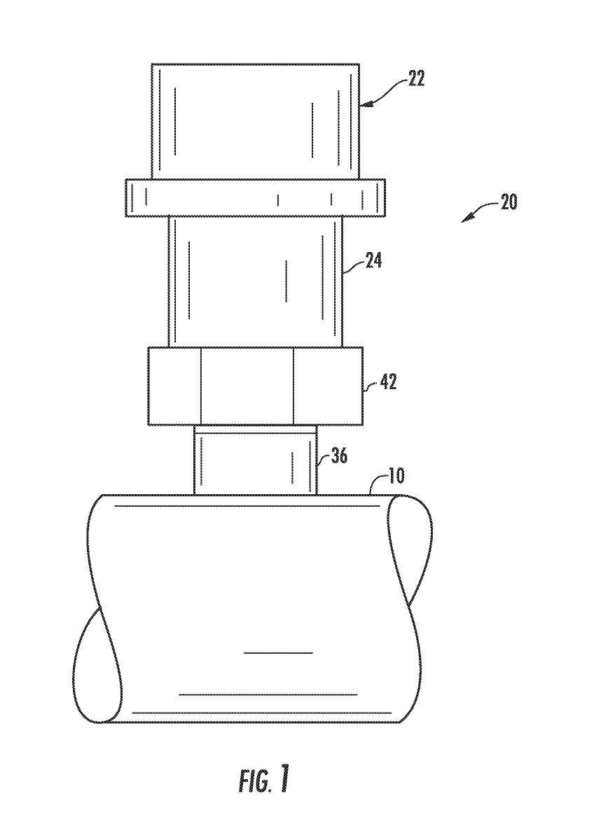

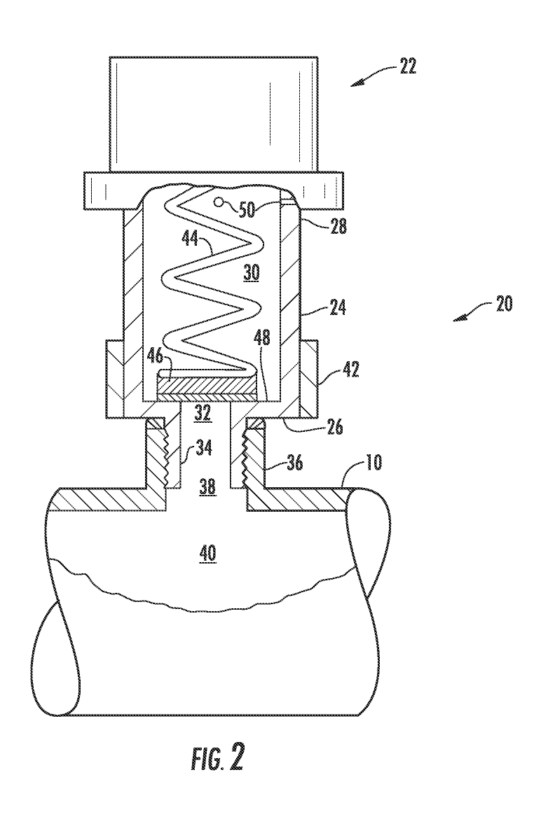

Referring initially to FIGS. 1 and 2, the pressure relief valve (PRV), designated generally by 20, is shown installed on a fluid flow conduit 10 of a closed system, such as, for example, a refrigerant conveying tube of a refrigerant circuit of a refrigerant vapor compression system. The PRV 20 disclosed herein is particularly suited for use in connection with refrigerant vapor compression systems operating at high refrigerant pressures and exposed to harsh environmental conditions such as, but not limited, to refrigerant vapor compression systems charged with carbon dioxide as a refrigerant and used in connection with transport refrigerant units for refrigerating the cargo space of a truck, trailer, sea-going container, intermodal container or other mobile refrigerated cargo box. It is to be understood, however, that the PRV 20 disclosed herein may also be used in connection with other closed systems wherein a high pressure fluid systems is contained in a tank or other vessel or circulated through a pipe, tube or other conduit.

The PRV 20 includes a protective cap 22 and an elongated valve body 24 having a proximal end, generally designated by 26, and a distal end, generally designated by 28, and defines interiorly thereto a valve chamber 30. The proximal end 26 includes a central inlet opening 32 and an axially extending, externally threaded tip 34. To install the PRV 20, the tip 34 is received by and threaded into an internally threaded nipple 36 on the fluid flow conduit 10. The nipple 36 defines a fluid flow passage 38 opening in fluid flow communication with the flow passage 40 of the fluid flow conduit 10. The central inlet opening 32 extends through the tip 34 and, when the PRV 20 is installed on the fluid flow conduit 10, is open to the fluid flow passage 38 of the nipple 36. A nut-like circumferential flange 42 may be provided on the exterior of the proximal end 26 for receiving a wrench for facilitating threading the PRV 20 into the nipple 36.

In FIGS. 2-6, the PRV 20 is shown, for purposes of illustration, but not limitation, as a spring-loaded PRV and is illustrated in FIG. 2, in a sealed condition. As in conventional spring-loaded pressure relief valves, a compression spring 44 is disposed within the valve chamber 30 coaxially with the longitudinal axis of the valve chamber 30. The compression spring 44 imposes an axially directed biasing force against a valve seal member 46 so as to force the valve seal member 46 against a valve seat 48 disposed around and about the central inlet opening 32, and thereby close the central inlet opening 32 to fluid flow. Only in the event of a over pressure condition in the fluid flow conduit 10, wherein the fluid pressure force exerted against the valve seal member 46 exceeds the opposing spring bias force exerted against the valve seal member 46, will the central inlet opening 32 open to allow high pressure fluid from the fluid flow conduit 10 to enter the valve chamber 30. The high pressure fluid passes through the valve chamber 30 to vent therefrom to the atmosphere through a plurality of vent holes 50, extending through the side wall of the valve body 24 at the distal end 28 of the PRV 20, thereby relieving the over-pressure condition. Once the pressure within the fluid flow conduit has been reduced sufficiently for the spring bias force imposed upon the valve seal member 46 to again exceed the opposing fluid pressure force exerted on the valve seal member 46, the valve seal member 46 will reseat against the valve seat 48 and again close the central inlet opening 32.

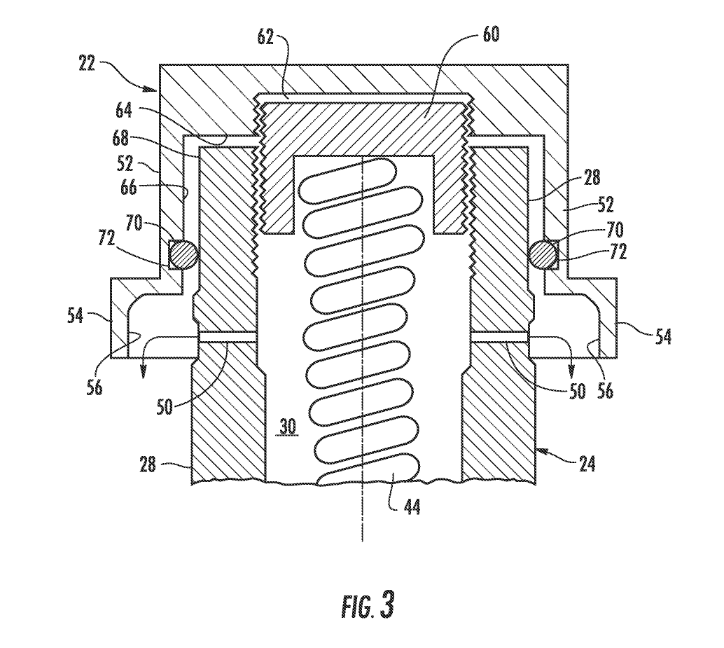

Referring to FIG. 3 in particular, the distal end of the compression spring 44 abuts a selectively adjustable set screw 60. The open distal end 28 of the valve body 24 is provided with internal threads and the set screw 60 is provided with external threads whereby the set screw 60 may threaded into the open distal end 28 of the valve body 24. The spring bias force imposed upon the valve seat member may be selectively adjusted, as in conventional spring-loaded pressure relief valves, by threading the set screw 60 deeper into the open distal end 28 of the valve body 24 to increase the spring bias force by further compressing the compression spring 44 and by backing the set screw 60 further out of the open distal end 28 of the valve member 24 to decrease the spring bias force by further relaxing the compression spring 44.

As noted previously, the PRV 20 disclosed herein includes a protective cap 22. The protective cap 22 is disposed over the distal end 28 of the valve body 24 as depicted in FIGS. 1-7. The protective cap 22 has a cylindrical body 52 having a closed base end and an open end and has a skirt flange 54 extending about the circumference of the open end of the cylindrical body 52. The skirt flange 54 extends outwardly from the body 52 to extend past the vent holes 50 opening through the wall of the valve body 24. Thus, when high pressure fluid vents from the valve chamber 30 through the vent holes 50, the skirt flange 54, being juxtaposed opposite the vent holes 50, deflects the high pressure fluid stream along the exterior of the valve body 24 as illustrated in FIG. 3.

Without the skirt flange 54, the high pressure fluid streams venting through the vent holes 50 would discharge radially outwardly and could expose service personnel in proximity to the PRV 20 to the high pressure fluid, which in a refrigerant vapor compression system could also be a high temperature refrigerant vapor. With the PRV 20 having a skirt flange 54 being installed in a vertical orientation, the high pressure fluid streams impacting upon the radially inner surface 56 of the skirt flange 54 are directed along the exterior of the body of the PRV 20 and thus deflected away from personnel in proximity to the PRV 20, thus reducing the potential for exposure to the high pressure fluid.

The protective cap 22 is secured to the PRV 20 disclosed herein by threading the protective cap 22 to distal end 28 of the valve body 24 either directly or indirectly through the cap screw 60. The protective cap 22 cannot be adequately and reliably secured to the distal end 28 of the valve body 24 by a simple interference fit between the exterior surface of the distal end 28 of the valve body 24 and the interior surface of the protective cap 22 due to the high pressure of the fluid venting into the valve chamber 30 in the event the PRV 20 actuates. A cap held by a simple interference fit could be blown off the pressure relief valve.

In the embodiment depicted in FIG. 3, the closed end of the body 52 of the protective cap 22 has a threaded recess 62 formed in the inside face 64 of the protective cap 22 facing the open distal end 28 of the valve body 24. In this embodiment, the protective cap 22 is secured to the valve body 24 by aligning the recess 62 with the exteriorly thread end of the set screw 60 protruding from the open distal end 28 of the valve body 24 and threading the protective cover 22 onto the exteriorly threaded set screw 60, which itself is threaded into the open distal end 28 of the valve body 24 as hereinbefore described. In this manner, the protective cap 22 is indirectly secured to the valve body 24 through the set screw 60.

The body 52 of the protective cap 22 defines an inner circumferential surface 66 that extends longitudinally from the inside face 64 toward the valve body 24. The inner circumferential surface 66 extends parallel to and in spaced relationship with outer circumferential surface 68 of a tip portion of the distal end 28 of the valve body 24. The inner circumferential surface 66 is juxtaposed radially outboard of and in spaced relationship with the outer circumference surface 68 thereby forming a gap therebetween. To protect both the threads between the cap 22 and the set screw 60 and the threads between the set screw 60 and the distal end 28 of the valve body 24, a circumferential seal member 70, for example a compressible O-ring seal formed of an elastomeric material, is disposed in a circumferential recess 72 and extends radially outward to contact in sealing relationship the inner circumferential wall 66 of the body 52 of the protective cap 22. So positioned, the circumferential seal member 70 seals the gap between the inner circumferential surface 66 of the body 52 of the protective cap 22 and the outer circumferential surface 68 of the distal end 28 of the valve body 24.

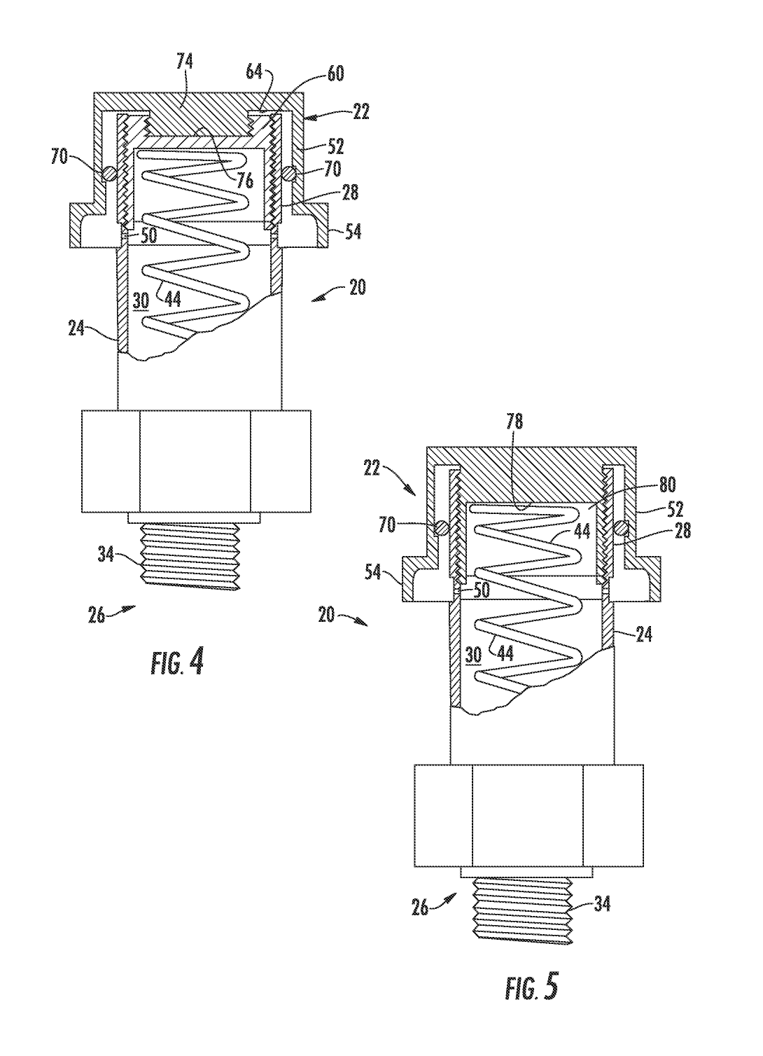

In the embodiment of the PRV 20 depicted in FIG. 3, the protective cap 22 is indirectly secured to the valve body 24 through the set screw 60 as described hereinbefore. However, other embodiments are contemplated for securing the protective cap 22 disclosed herein to the distal end 28 of the valve body 24, such as, for example, as depicted in FIGS. 4-5. In the embodiment depicted in FIGS. 4, the closed end of the body 52 of the protective cap 22 has a threaded head 74 formed on and extending axially outwardly from the inside face 64 of the protective cap 22 facing the open distal end 28 of the valve body 24. In this embodiment, the protective cap 22 is secured to the valve body 24 by aligning the threaded head 74 with an interiorly threaded recess 76 in the end face of the set screw 60 and threading the protective cover 22 into the interiorly threaded set screw 60, which itself is threaded into the open distal end 28 of the valve body 24 as hereinbefore described. In this manner, the protective cap 22 is again indirectly secured to the valve body 24 through the set screw 60.

However, in the embodiment of the PRV 22 depicted in FIG. 5, the protective cap 22 is directly secured to the valve body 24. In this embodiment, the set screw 60 is formed integrally with the body 52 of the protective cap 22. The set screw 60 is formed as exteriorly threaded head portion 78 of the body 52 that extends axially outwardly from the inside face 62 off the body 52 of the protective cap 22. The head portion 78 includes an open cavity 80 for receiving a distal end of the compression spring 44 when the protective is installed on the PRV 20. To install the protective cap 22 on the PRV 20, the protective cap 22 is axially aligned with the open distal end 28 of the valve body 24 such that the cavity 80 is positioned to receive the distal end of the compression spring 44 and then threaded into the interiorly threaded tip of the distal end 28 of the valve body 24 thereby securing the protective cap 22 to the valve body 24 with the skirt flange 54 extending past the vent holes 50. In this embodiment, the bias force exerted by the compression spring 44 on the valve sealing member 46 (see FIG. 2) is adjusted by turning the protective cap 22 to adjust the depth of insertion of the head portion 78 into the open end of the distal end 28 of the valve body 24 to further compress or to relax the compression spring 44, as desired.

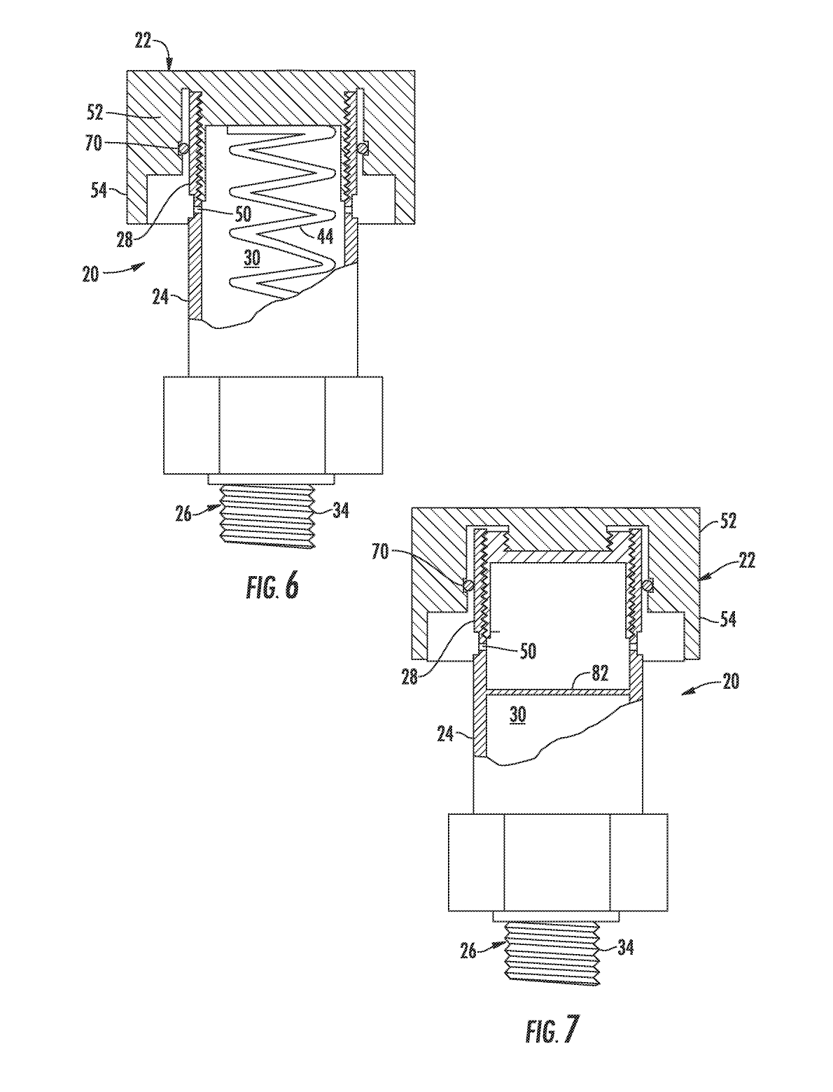

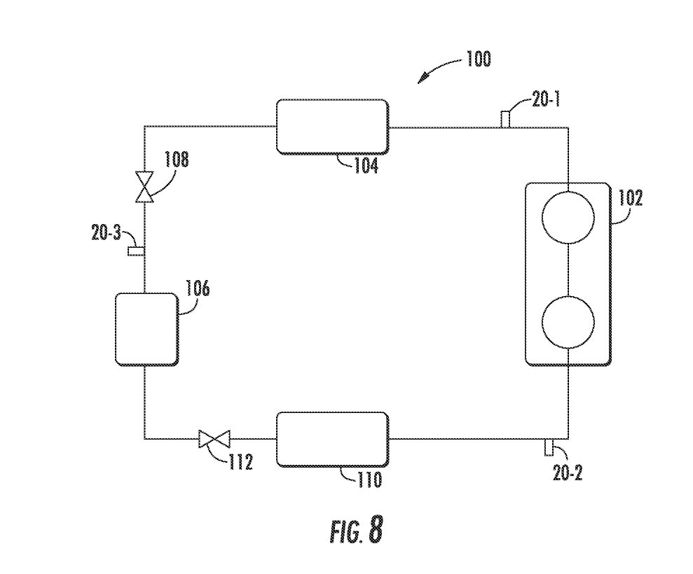

In FIGS. 6 and 7, the exterior configuration of the protective cap 22 differs somewhat from the exterior configuration of the protective cap 22 as illustrated in FIGS. 1-5. It is to be understood that the exterior configuration of the protective cap 22 is not germane to the invention and may take any desired shape so long a skirt flange 54 is provided with an inside surface juxtaposed opposite the vent holes 50. In each of FIGS. 1-7, the inside surface 56 of the skirt flange 54 is juxtaposed opposite the vent holes 50 in radially outwardly spaced relationship from the exterior surface of the valve body 24. The specific magnitude of the spacing is a matter of design choice. The spacing should be large enough that a service technician may readily observe the vent holes 50, but small enough to ensure that a stream of high pressure fluid exiting through a vent hole 50 in the event the PRV 22 actuates will be deflected by the inside surface 56 of the skirt 54 in a direction generally along the exterior surface of the valve body 24.

Visibility of the vent holes 50 is desirable, as the vent holes 50 may be covered with a visual actuation indicator covering, such as for example a piece of tape (not shown), which is readily blown away when the PRV 20 actuates. Absence of the visual actuation indicator conveys to service personnel that the PRV 20 has actuated. Visibility of vent holes 50 is desirable as the absence of the visual actuation indicator may be the only indication that a self-reseating PRV 20 has previously actuated, thereby indicating a possible problem with the system on which the PRV 20 is installed.

In FIGS. 1-6, the PRV 20 having a protective cap 22 as disclosed herein is shown for purposes of illustration, but not limitation, as comprising a spring loaded pressure relief valve. It is contemplated that the protective cap 22 may be used in connection with other types of pressure relief valves. For example, in the embodiment depicted in FIG. 7, the PRV 20 comprises a rupture disc type pressure relief valve. In the embodiment depicted in FIG. 7, the compression spring and the seal member are replaced with a conventional rupture disc 82 disposed within or at the inlet to the valve chamber 30. In the event that the disc 82 ruptures, as in response to an over-pressure condition within the conduit 10, high pressure vapor would be expelled from the conduit 10 through the valve chamber 30 and discharged through the vent holes 50 to the environment exterior of the valve body 24. The discharging high pressure fluid would be deflected by the inside surface 56 of the skirt flange 54 along the exterior of the valve body 24 and away from personnel who might be in proximity to the PRV 20.

It is to be understood that it is not necessary to deflect the high pressure fluid substantially parallel to the longitudinal axis of the valve body 24. Rather, to protect service personnel from potential exposure to high pressure fluid in the event of the actuation of the PRV 20, the skirt flange 54 should be orientated in consideration of the orientation of the PRV 20 itself such that high pressure fluid exhausted through the vent holes 50 would be deflected by the inside surface 56 of the skirt flange 54 in a direction most likely to avoid contact with service personnel who might be in the vicinity of the PRV 20.

In the embodiments of the PRV 20 as depicted in FIGS. 1-7, the protective cap 22 provides both personnel protection against exposure to high pressure fluid through the provision of the skirt flange 54 and corrosion protection for the PRV 20 itself through the provision of the valve sealing member 70 disposed between the inner surface of the protective cap 22 and the exterior surface of the distal end 28 of the valve body 24. However, the skirt flange 54 may be embodied for personnel protection in a protective cap for a pressure relief valve employing a different sealing means. Similarly, the valve sealing member 70 disposed as disclosed herein may be incorporated on pressure relief valves having a cap that does not incorporate a skirt flange as disclosed herein.

As mentioned previously, the PRV 20 disclosed herein is particularly suited for use in connection with refrigerant vapor compression systems operating at high refrigerant pressures and exposed to harsh environmental conditions. Referring now to FIG. 8, there is depicted a refrigerant vapor compression system 100 charged with carbon dioxide as a refrigerant and used in connection with transport refrigerant units for refrigerating air drawn from and supplied to the cargo box of a truck, trailer, sea-going container, intermodal container or other refrigerated transport container, referred to herein by the common term “refrigerated transport container”. The refrigerant vapor compression system 100 may be charged with carbon dioxide as the refrigerant and may be designed for operation in a transcritical cycle.

In the depicted embodiment, the refrigeration vapor compression system includes a compression device 102, a refrigerant vapor cooler heat exchanger 104, a flash tank economizer 106, an economizer expansion device 108, a refrigerant evaporator heat exchanger 110, and an evaporator expansion device 112 disposed in a closed refrigerant flow circuit 114 as depicted in FIG. 8 in a convention refrigeration cycle. The refrigerant heat absorption heat exchanger functions as a refrigerant evaporator and is disposed in heat exchange relationship with air to be cooled and supplied to the cargo box of the refrigerated transport container. Pressure relief valves 20, equipped with protective caps as disclosed herein, may be installed at various locations throughout the refrigerant flow circuit.

For example, in the embodiment depicted in FIG. 8, a PRV 20 (designated 20-1) is installed in a high pressure side of the refrigerant flow circuit between the discharge outlet of the compression device 102 and the inlet to the refrigerant vapor cooler heat exchanger 104, a PRV 20 (designated 20-2) is installed in a low pressure side of the refrigerant flow circuit between the outlet of the refrigerant evaporator heat exchanger 110 and the suction inlet to the compression device 102, and a PRV 20 (designated 20-3) is installed in an intermediate pressure side of the refrigerant flow circuit between the outlet of the economizer expansion device 108 and the inlet to the flash tank economizer 106. In an embodiment, the pressure relief valve 20-1 is configured to when exposed to a predetermined pressure level in the refrigerant circuit selected in the range from about 2200 psia (pounds per square inch atmospheric) to about 2500 psia (about 152 to about 172 bars). In an embodiment, the pressure relief valve 20-2 is configured to when exposed to a predetermined pressure level in the refrigerant circuit selected in the range from about 1300 psia to about 1500 psia (about 90 to about 103 bars).

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiments as illustrated in the drawing, it will be recognized by those skilled in the art that various modifications may be made without departing from the spirit and scope of the invention. Therefore, it is intended that the present disclosure not be limited to the particular embodiment(s) disclosed as, but that the disclosure will include all embodiments falling within the scope of the appended claims.

1. A pressure relief valve for use in connection with a high pressure fluid system, said pressure relief valve comprising a protective cap for limiting the exposure of personnel to a high pressure fluid venting from the pressure relief valve in response to an over pressure condition within the fluid system.

2. The pressure relief valve as set forth in clam 1 wherein said protective cap includes a skirt flange disposed to deflect the high pressure fluid venting from the pressure relief valve.

3. The pressure relief valve as set forth in claim 2 further comprising a valve body having at least one vent hole establishing fluid flow communication between a valve chamber and an environment external of said valve body, said protective cap mounted to said valve body with said skirt flange defining a surface juxtaposed opposite the at least one vent hole for deflecting the high pressure fluid venting through the at least vent hole along an exterior of said valve body.

4. The pressure relief valve as set forth in claim 1 installed on a transport refrigeration unit having a refrigeration vapor compression system charged with carbon dioxide as a refrigerant.

5. The pressure relief valve as set forth in claim 1 wherein said pressure relief valve comprises a spring-loaded pressure relief valve.

6. The pressure relief valve as set forth in claim 1 wherein said pressure relief valve comprises a rupture disc pressure relief valve.

7. A pressure relief valve for use in connection with a high pressure fluid system comprising:
a valve body extending along a longitudinal axis and defining a valve chamber, said valve body having a proximal end and a distal end longitudinally opposite said proximal end, said distal end having at least one vent hole opening through said distal end and providing a fluid flow passage for venting high pressure fluid from the valve chamber to an environment exterior of the valve body in a direction generally transverse to the longitudinal axis; and
a protective cap mounted to said distal end, said protective cap having a skirt flange disposed in spaced relationship to said distal end and defining a surface juxtaposed opposite the at least one vent hole for deflecting high pressure fluid venting from the valve chamber through the at least one vent hole away from an outwardly directed path generally transverse to the longitudinal axis of the valve body.

8. The pressure relief valve as set forth in claim 7 wherein said surface defined by said skirt flange extends generally parallel to the longitudinal axis of the valve body.

9. The pressure relief valve as set forth in claim 7 wherein:
the at least one vent hole comprises a plurality of circumferentially spaced vent holes disposed about a circumference of said distal end of the valve body; and
said skirt flange comprises a circumferential extending flange circumscribing said distal end of the valve body.

10. The pressure relief valve as set forth in claim 7 wherein said surface defined by said skirt flange deflects high pressure fluid venting from the valve chamber through the at least one vent hole in a direction generally toward a proximal end of the valve body.

11. The pressure relief valve as set forth in claim 7 wherein said surface defined by said skirt flange deflects high pressure fluid venting from the valve chamber through the at least one vent hole in a direction generally along an exterior surface of the valve body.

12. The pressure relief valve as set forth in claim 7 wherein said protective cap comprises a cylindrical cap body secured to said distal end of the valve body, the cap body having a closed base end and an open end, said skirt flange extending circumferentially about the open end of the cap body.

13. The pressure relief valve as set forth in claim 12 wherein the cap body is threaded directly to said distal end of the valve body.

14. The pressure relief valve as set forth in claim 12 wherein the cap body is threaded to an intermediate member and the intermediate member is threaded directly to said distal end of the valve body.

15. The pressure relief valve as set forth in claim 12 further comprising a circumferential seal member disposed between an inner circumferential surface of the cap body and an outer circumferential surface of said distal end of the valve body.

16. The pressure relief valve as set forth in claim 15 wherein the circumferential seal member comprises a compressible O-ring seal.

17. A refrigerant vapor compression system comprising:
a refrigerant circuit charged with carbon dioxide as a refrigerant and having in serial refrigerant flow relationship a compression device for comprising a refrigerant, a refrigerant heat rejection heat exchanger, a first expansion device, an economizer, a second expansion device, and a refrigerant heat absorption heat exchanger disposed in heat exchange relationship with air to be refrigerated and supplied to a cargo box of a refrigerated transport container; and
at least one pressure relief valve disposed in said refrigerant circuit for relieving pressure therein when the pressure exceeds a predetermined pressure level, said at least one pressure relief valve having a protective cap for limiting the exposure of personnel to high pressure refrigerant vapor venting from said at least one pressure relief valve in response to an over pressure condition within the refrigerant circuit.

18. The refrigerant vapor compression system as set forth in claim 17 wherein said at least one pressure relief valve includes a pressure relief disposed between the compression device and the refrigerant heat rejection heat exchanger, said pressure relief valve configured to actuate when exposed to a predetermined pressure level in the refrigerant circuit selected in the range from about 2200 psia to about 2500 psia.

19. The refrigerant vapor compression system as set forth in claim 17 wherein said at least one pressure relief valve includes a pressure relief disposed between the refrigerant heat absorption heat exchanger and the compression device, said pressure relief valve configured to actuate when exposed to a predetermined pressure level in the refrigerant circuit selected in the range from about 1300 psia to about 1500 psia.

20. The refrigerant vapor compression system as set forth in claim 17 wherein said at least one pressure relief valve includes a pressure relief disposed between the first expansion device and the economizer.
